(19) United States
(12) Patent Application Publication
(10) Pub. No.: US 2022/0279041 A1
(43) Pub. Date: Sep. 1, 2022

(54) DATA SHARING SYSTEM, MANAGEMENT TERMINAL, DATA SHARING METHOD, AND DATA SHARING PROGRAM

(71) Applicant: Nippon Telegraph and Telephone Corporation, Tokyo (JP)

(72) Inventors: Tatsuro ISHIDA, Musashino-shi, Tokyo (JP); Atsushi NAKADAIRA, Musashino-shi, Tokyo (JP); Shigeru Fujimura, Musashino-shi, Tokyo (JP); Shigenori Ohashi, Musashino-shi, Tokyo (JP); Hiroki Watanabe, Musashino-shi, Tokyo (JP)

(21) Appl. No.: 17/625,569

(22) PCT Filed: Jul. 10, 2019
(86) PCT No.: PCT/JP2019/027357

§ 371 Date: Jan. 7, 2022

(51) Int. Cl. H04L 67/1095; G16Y 40/35; G16Y 10/75

(52) U.S. Cl. CPC H04L 67/1095; G16Y 40/35; G16Y 10/75

(57) ABSTRACT

A data sharing system includes a plurality of IoT networks 20, and a plurality of management terminals 1 connected to a blockchain network 10. In the data sharing system, each management terminal 1 includes a reception unit 12 that receives a transaction including IoT terminal information related to an IoT terminal 2 from at least one IoT network 20 of the plurality of the IoT networks 20, a communication unit 13 that transmits and receives the transaction to/from another management terminal 1, a block generation unit 14 that attempts to generate a block including the transaction, a block verification unit 15 that verifies a block generated by another management terminal 1, and a distributed ledger 16 that stores the generated blocks.

### TECHNICAL FIELD

The present invention relates to a data sharing system, a management terminal, a data sharing method, and a data sharing program.

### BACKGROUND ART

In IoT (Internet of Things), IoT terminals that are nodes communicate with each other. Methods for managing and coordinating such IoT terminals include a method in which a management server that manages IoT terminals is deployed. Patent Literature 1 discloses a technology in which a node participating in an IoT network is handled on a specified terminal.

A blockchain is known, as a mechanism that can ensure reliability with no need for centralized management. In the blockchain, reliability of exchanged information is ensured through a consensus building process in a distributed network, and soundness is maintained by preventing fraud, such as falsification and double-spending, in a system-wide manner. In the blockchain, inter-participant transaction information (transactions) is collected in a unit of “block”, each block is concatenated one after another and managed in chronological order. Non-Patent Literature 1 discloses technology related to the blockchain.

### CITATION LIST

### Patent Literature

Patent Literature 1: Japanese Patent Laid-Open No. 2018-125647

### Non-Patent Literature

Non-Patent Literature 1: Junichi Kishigami, Shigeru Fujimura, Hiroki Watanabe, Shigenori Ohashi, Atsushi Nakadaira, “Introduction to Blockchain Technology”, Morikita Publishing (2017), pp. 77-78

### SUMMARY OF THE INVENTION

### Technical Problem

For IoT networks, unified standardization of implementation methods is underway. Therefore, current IoT networks are siloed, and it is difficult to share information between or among a plurality of IoT networks.

If an attempt is made to monitor a plurality of IoT networks, a monitoring server is needed that monitors management servers installed for the IoT networks, respectively, and a mechanism for alive monitoring of the monitoring server is further needed, and accordingly a system configuration become large in scale and complicated.

An object of the present invention, which has been devised in view of the above described problems, is to provide a technology that makes it possible to easily share information in a plurality of IoT networks.

### Means for Solving the Problem

To achieve the object, an aspect of the present invention provides a data sharing system that includes a plurality of IoT networks, and a plurality of management terminals connected to a blockchain network, in which each of the management terminals includes a reception unit that receives a transaction including IoT terminal information related to an IoT terminal from at least one IoT network of the plurality of the IoT networks, a communication unit that transmits and receives the transaction to/from another management terminal, a block generation unit that attempts to generate a block including the transaction, a block verification unit that verifies a block generated by another management terminal, and a distributed ledger that stores the generated blocks.

An aspect of the present invention provides a management terminal connected to a blockchain network. The management terminal includes a reception unit that receives a transaction including IoT terminal information related to an IoT terminal from at least one IoT network of a plurality of IoT networks, a communication unit that transmits and receives the transaction to/from another management terminal, a block generation unit that attempts to generate a block including the transaction, a block verification unit that verifies a block generated by another management terminal, and a distributed ledger that stores the generated blocks.

An aspect of the present invention provides a data sharing method performed by a data sharing system, in which the data sharing system includes a plurality of IoT networks, and a plurality of management terminals connected to a blockchain network. The data sharing method includes by each of the IoT networks, transmitting a transaction including IoT terminal information related to an IoT terminal to at least one management terminal, by each of the management terminals, receiving the transaction from at least one IoT network of the plurality of IoT networks, transmitting and receiving the transaction to/from another management terminal, attempting to generate a block including the transaction, or verifying a block generated by another management terminal, and storing the generated block in a distributed ledger.

An aspect of the present invention provides a data sharing program for causing a computer to function as the management terminal.

### Effects of the Invention

According to the present invention, a technology that makes it possible to easily share information in a plurality of IoT networks can be provided.

### BRIEF DESCRIPTION OF DRAWINGS

FIG. 1 shows an entire configuration of a data sharing system according to an embodiment of the present invention.

FIG. 2 is a block diagram showing a configuration of a management terminal.

FIG. 3 is a block diagram showing a configuration of an IoT terminal.

FIG. 4 is a sequence chart showing operation of the data sharing system.

FIG. 5 is a sequence chart showing another operation of the data sharing system.

FIG. 6 is an explanatory diagram for explaining processing performed when an IoT network is added.

FIG. 7 is an explanatory diagram for explaining processing performed when a new management terminal is added.

FIG. 8 is an entire configuration diagram of a data sharing system according to a modification example.

FIG. 9 is an example of a hardware configuration of the management terminals and the IoT terminals.

### DESCRIPTION OF EMBODIMENTS

Hereinafter, an embodiment of the present invention will be described with reference to drawings. In a description of the drawings, the same portions are denoted by the same reference numerals, and an overlapping description thereof will be omitted.

(Configuration of Data Sharing System)

In the present embodiment, a distributed ledger on a blockchain and a smart contract is used for a history, whereby data sharing between or among a plurality of IoT networks is achieved. Each terminal (blockchain node) included in a blockchain includes a distributed ledger in which the latest-state blockchain is stored nearly in real time through loose synchronization with all terminals connected to a blockchain network. In other words, individual terminals store information on each other while replicating the information, mutually verify the information, and store the distributed ledgers with the same contents.

In the present embodiment, the terminals in the blockchain, each monitoring at least one IoT network, exchange information on the monitored IoT network with each other and keep the distributed ledgers, whereby data sharing between or among a plurality of a plurality of the IoT networks is achieved.

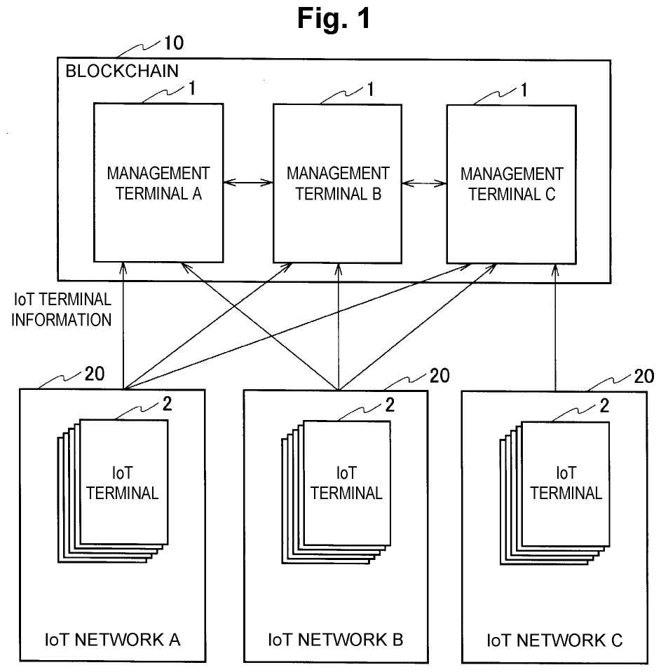

FIG. 1 shows an entire configuration of a data sharing system of the present embodiment. The blockchain in the present embodiment is a smart contract blockchain, and Ethereum, which is one of blockchain infrastructure technologies, is used for the blockchain. Ethereum is an application development platform for allowing a blockchain to be used for a distributed ledger that records state transitions. However, the blockchain is not limited to Ethereum, and the data sharing system of the present embodiment may be used for blockchains other than Ethereum.

The data sharing system shown in FIG. 1 includes a plurality of management terminals 1 (management terminals A, B, and C) connected to a blockchain network 10, and a plurality of IoT networks 20 (IoT networks A, B, and C).

The management terminals 1 are blockchain nodes, each of which manages an IoT terminal 2 in at least one of the IoT networks 20. The management terminals 1 are connected to the blockchain network, which is a P2P network, in an autonomous and decentralized manner. The management terminals 1 connected to the blockchain network 10 each include a distributed ledger, which will be described later, and maintain a system by mutually verifying data and transactions recorded in the distributed ledgers. Note that although the three management terminals 1 are depicted in the drawing, the number of management terminals 1 is not limited to three.

The IoT networks 20 are networks constructed by individual companies, respectively. For example, it is assumed that the IoT network A is constructed by a company in Tokyo, the IoT network B is constructed by a company in Osaka, and the IoT network C is constructed by a university in Hokkaido. A plurality of IoT terminals 2 is connected to each IoT network 20. Each IoT terminal 2 is, for example, a sensor terminal or the like and transmits measured or acquired data to at least one of the management terminals 1 via the network.

(Configuration of Management Terminal)

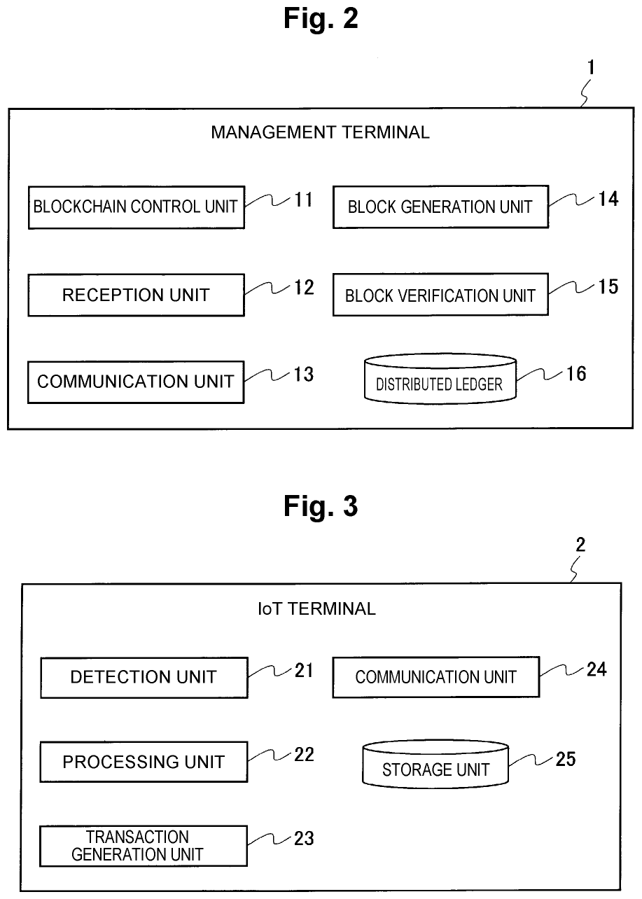

FIG. 2 is a block diagram showing a configuration of any one of the management terminals 1 in the present embodiment. Each management terminal 1 in the present embodiment manages at least one of the IoT networks 20. Each management terminal 1 collects a transaction transmitted from an IoT terminal 2 or another management terminal 1 and, after confirming correctness, generates a block through an operation for consent.

The depicted management terminal 1 includes a blockchain control unit 11, a reception unit 12, a communication unit 13, a block generation unit 14, a block verification unit 15, and a distributed ledger 16.

The blockchain control unit 11 maintains the blockchain system by cooperating, in an autonomous and decentralized manner, with the management terminals 1 connected to the blockchain network. The blockchain control unit 11 accesses the distributed ledger 16 and reads or updates the blockchain and a dataset in the distributed ledger 16.

In the distributed ledger 16, the latest-state blockchain is stored nearly in real time through loose synchronization, via the blockchain control unit 11, with all of the terminals connected to the blockchain network. The blockchain and the dataset managed by the blockchain are stored in the distributed ledger 16 in the present embodiment. A block that is generated by the own management terminal 1 or any other management terminal 1 and that includes IoT terminal information is stored in the distributed ledger 16 in the present embodiment.

The reception unit 12 receives, from at least one IoT network 20 of the plurality of IoT networks 20, a transaction including IoT terminal information related to an IoT terminal 2. The communication unit 13 transmits and receives a transaction received from an IoT terminal 2, to/from any other management terminal.

The block generation unit 14 attempts to generate a block including a transaction. In other words, the block generation unit 14 verifies a transaction and attempts to generate a block in accordance with a consensus algorithm for block generation, such as Proof of Work. Specifically, the block generation unit 14 includes a consensus execution unit, a transaction verification unit, and a block issuance unit, which are not shown.

The consensus execution unit performs calculation required for consensus, such as a hashing operation. As the consensus algorithm, in addition to Proof of Work, which is used for bitcoin, any other consensus algorithm for block generation may be used, such as Proof of Stake in which the quantity of owned coins is used for a resource, or PBFT that is a consensus algorithm in a Byzantine failure.

After the transaction verification unit receives a transaction, the transaction verification unit verifies the transaction, such as correctness of an electronic signature on the received transaction. The block issuance unit generates one block by aggregating transactions issued within a predetermined time period in the blockchain network. In other words, if verification by the transaction verification unit succeeds, the block issuance unit generates a block including the transaction and has the generated block reflected in the distributed ledgers 16 of all terminals connected to the blockchain network.

The block verification unit 15 verifies a block generated by another management terminal 1. Specifically, the block verification unit 15 verifies correctness of a block that is generated by another management terminal 1 and added to the own distributed ledger, for example, by performing hash calculation using a block header for an input value. The block verification unit 15 verifies whether a solution presented by the other management terminal is a correct solution.

(Configuration of IoT Terminal)

FIG. 3 is a block diagram showing a configuration of any one of the IoT terminals 2 connected to the IoT networks 20 in the present embodiment. The depicted IoT terminal 2 includes a detection unit 21, a processing unit 22, a transaction generation unit 23, a communication unit 24, and a storage unit 25.

The detection unit 21 detects or measures a predetermined type of physical amount. For example, the detection unit 21 may be a sensor that acquires an ambient temperature, humidity, or the like.

The processing unit 22 performs predetermined computational processing. For example, the processing unit 22 stores, in the storage unit 25, detection data (a temperature, a humidity, or the like) detected by the detection unit 21, together with a time acquired from a clock unit (not shown).

The transaction generation unit 23 generates a transaction including IoT terminal information, based on information stored in the storage unit 25. The IoT terminal information includes, for example, a terminal ID, a time, detection data detected by the detection unit 21, and the like. The terminal ID is identification information that is stored in the storage unit 25 and that uniquely specifies the own terminal. The transaction generation unit 23 generates a transaction including IoT terminal information and an electronic signature of the IoT terminal information. The transaction is a transaction for registering the IoT terminal information in the distributed ledger 16 of each management terminal 1.

The communication unit 24 communicates with any management terminal 1 in the blockchain or any other IoT terminal 2 in the same IoT network 20. In the present embodiment, the communication unit 24 transmits a transaction generated by the transaction generation unit 23 to at least one of the management terminals 1.

The storage unit 25 stores the terminal ID, an own private key for an electronic signature, detection data detected by the detection unit 21, a time at which the detection data is acquired, and the like.

(System Operation)

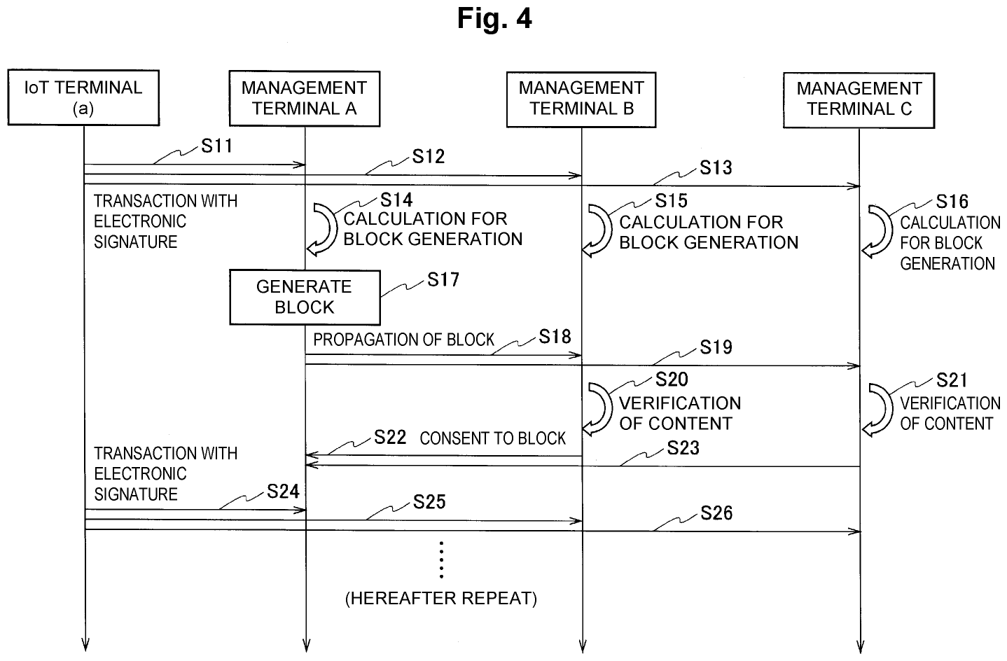

FIG. 4 is a sequence chart showing operations of the data sharing system according to the present embodiment. In an illustrated example, an IoT terminal (a) belonging to the IoT network A generates a transaction including IoT terminal information on the own IoT terminal, and transmits the transaction to at least one management terminal (S11, S12, and S13). Here, the IoT terminal (a) transmits the transaction to all of the management terminals A, B, and C connected to the blockchain network. Note that the IoT terminal (a) periodically transmits a transaction including IoT terminal information to the management terminals 1.

Each management terminal A, B, and C performs computation for generating a block including the received transaction (S14, S15, and S16). As the computation for generating the block, for example, each management terminal A, B, and C verifies the transmitted transaction, and searches for a nonce for generating one block by aggregating the transaction together with other transactions that are generated within a predetermined time period.

Such block generation is performed competitively, and any management terminal, among the management terminals A, B, and C, that most quickly computes a solution (nonce or the like) generates the block including the received transaction. The generated block is added to the distributed ledger of the management terminal (S17).

Then, through loose synchronization among the terminals, the block including the transaction transmitted in S11 to S13 is reflected in the distributed ledgers of all management terminals connected to the blockchain network (S18 and S19). In other words, all management terminals add the block including the transaction in the distributed ledgers kept by the management terminals. Here, it is assumed that the management terminal A generates the block (S17), and that the generated block is propagated to the management terminals B and C (S18 and S19).

The management terminals B and C each verify the block generated by the other management terminal A (S20 and S21) and, if verification succeeds, transmit a message indicating consent to the block to the management terminal A (S22 and S23). For example, the management terminals B and C each verify whether the solution included in the block is a correct solution and, if the solution is a correct solution, consent the block. Note that a unit of data stored in the distributed ledger of each management terminal A, B, and C is a block in which a plurality of transactions is aggregated.

At a next transmission timing, the IoT terminal (a) generates a transaction including IoT terminal information and transmits the transaction to the management terminals A, B, and C as in S11, S12, and S13 (S24, S25, and S26). Thus, each management terminal A, B, and C performs the above described processing in S14 to S23. As described above, in the data sharing system of the present embodiment, the processing in S11 to S23 is performed repeatedly, whereby transactions (IoT terminal information) transmitted from the IoT terminal (a) is stored in the distributed ledger of each management terminal A, B, and C.

Although a case where transactions are transmitted from the single IoT terminal (a) is described as an example in FIG. 4, transactions similar to the transactions of the IoT terminal (a) are transmitted from each IoT terminal in the plurality of IoT networks to each management terminal A, B, and C. Thus, IoT terminal information on each IoT terminal in the plurality of IoT networks is stored in the a distributed ledger of each of management terminal A, B, and C. Accordingly, each management terminals A, B, and C in the present embodiment can share (store) the IoT terminal information in the plurality of IoT networks.

Note that the operation of each management terminal A, B, and C in S14 to S23 shown in FIG. 4 is an example, and operation may be different from the operation in S14 to S23, depending on specifications of a blockchain.

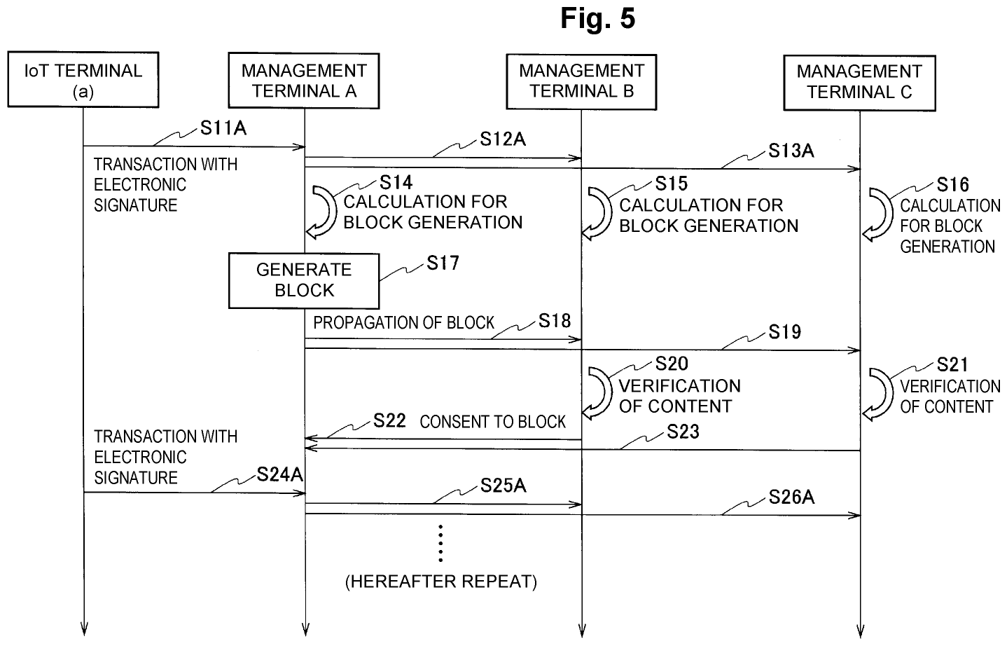

FIG. 5 is a sequence chart showing operation performed when the IoT terminal (a) transmits a transaction including IoT terminal information to one management terminal 1. In an illustrated example, the IoT terminal (a) transmits a transaction only to the management terminal A (S11A). The received transaction is transmitted and received between the management terminal A and the other management terminals B and C. Specifically, the management terminal A receives the transaction transmitted from the IoT terminal (a) and transmits the transaction to the other management terminals B and C connected to the blockchain network (S12A and S13A). Since subsequent S14 to S23 are similar to S14 to S23 in FIG. 3, a description thereof is omitted here.

Then, at a next transmission timing, the IoT terminal (a) generates a transaction including IoT terminal information and transmits the transaction to the management terminal A as in S11A (S24A). The management terminal A transmits the received transaction to other management terminals B and C as in S12A and S13A (S25A and S26A). Thus, each management terminal A, B, and C performs the above-described processing in S14 to S23.

For example, suppose that the management terminal A is deployed in Tokyo, the management terminal B is deployed in Osaka, the management terminal C is deployed in Sapporo, and the IoT network A is operated in Tokyo by the company in Tokyo. In the above case, it is inefficient for each IoT terminal in the IoT network A to directly communicate with the management terminals B and C at remote locations.

In such a case, each IoT terminal in the IoT network A deployed in Tokyo transmits a transaction only to the management terminal A that is deployed at the nearest location, and the management terminal A transmits the transaction to other management terminals B and C. Accordingly, communication loads on the IoT terminals can be reduced.

In FIG. 5, as in FIG. 4, IoT terminal information on each IoT terminal in the plurality of IoT networks is stored in the a distributed ledger of each of management terminals A, B, and C. Accordingly, each management terminal A, B, and C can share (store) the IoT terminal information in the plurality of IoT networks.

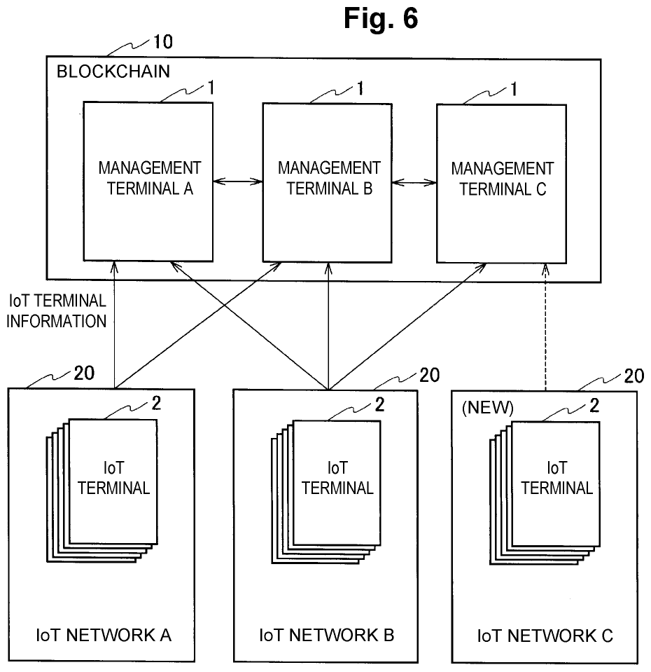

FIG. 6 is an explanatory diagram for explaining processing performed when an IoT network is newly added. It is assumed that the IoT network C is newly added when the IoT networks A and B exist. Each IoT terminal in the new IoT network C transmits a transaction including information on the own IoT terminal to at least one management terminal. Here, a case is exemplified in which each IoT terminal in the IoT network C transmits a transaction only to the management terminal C and does not transmit the transaction to the management terminals A and B.

In such a case, as described in FIG. 5, the management terminal C that has received the transaction transmits the transaction to other management terminals A and B connected to the blockchain network. Accordingly, the IoT terminal information on each IoT terminal in the new IoT network C is shared among all of the management terminals A, B, and C.

Note that in the present embodiment, an IoT terminal transmits the own IoT terminal information by using a transaction that is interpretable by the management terminals that are nodes of the blockchain. Accordingly, even if a new IoT network is added, a modification to the management terminals (a change, a correction to a program) is not needed.

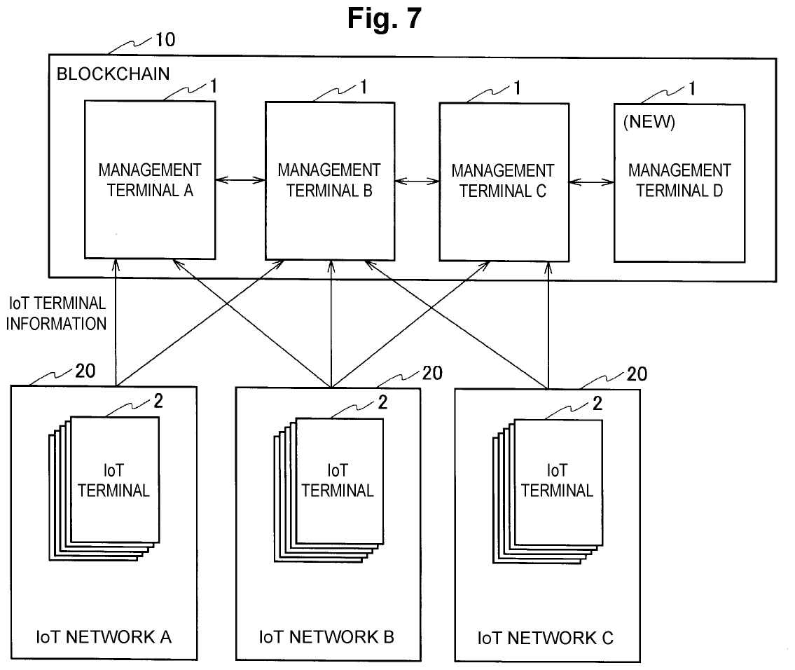

FIG. 7 is an explanatory diagram for explaining processing performed when a new management terminal is added to the blockchain network. Here, a new management terminal D autonomously accesses other management terminals A to C. Through loose synchronization among the terminals, contents of the distributed ledgers of the existing management terminals A to C are reflected in the distributed ledger of the management terminal D. Specifically, the blockchain control unit of the management terminal D replicates the content of the distributed ledger of any existing management terminal (here, the management terminal C) in the own distributed ledger. A past history (IoT terminal information) is stored in the distributed ledger of the existing management terminal. Accordingly, the new management terminal D functions as a node of the blockchain.

Thereafter, if a new IoT network is added at a location close to the management terminal D, the management terminal D receives a transaction from each IoT terminal in the new IoT network.

### Modification Example

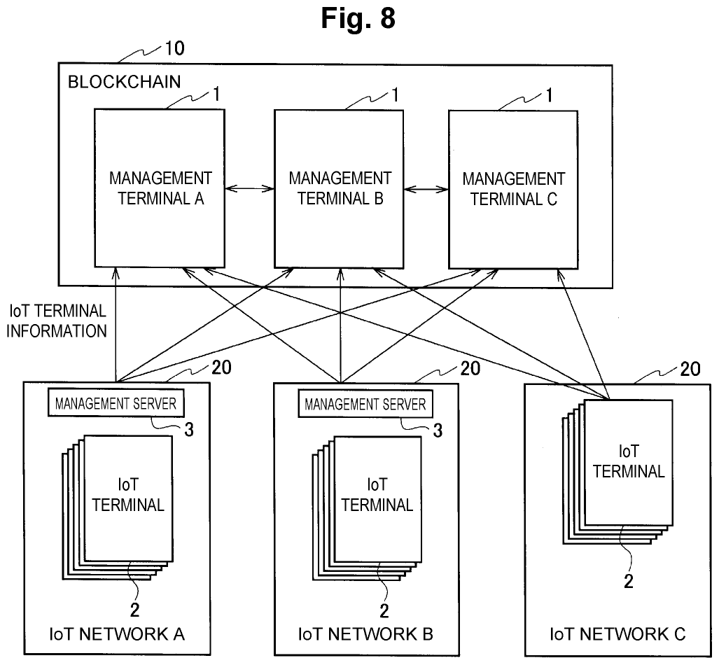

FIG. 8 is a configuration diagram of a modification example of the data sharing system of the present embodiment. In the modification example, a case is described where an IoT network 20 includes a management node 3. When an IoT network 20 is constructed, a management server 3 that manages a plurality of IoT terminals 2 is set in the IoT network 20 in some cases. In such a case, the management terminals 1 do not receive a transaction (IoT terminal information) directly from an IoT terminal 2, but receive a transaction via the management server 3. In other words, an IoT terminal 2 transmits a transaction to the management server 3, and the management server 3 transmits the transaction to the management terminals 1.

Note that as shown in the drawing, the IoT networks A and B that include the management servers 3 and the IoT network C that does not include the management server 3 may coexist.

The data sharing system of the present embodiment as described hereinabove includes a plurality of the IoT networks 20, and a plurality of the management terminals 1 connected to the blockchain network. Each management terminal 1 includes the reception unit 12, the communication unit 13, the block generation unit 14, the block verification unit 15, and the distributed ledger 16. The reception unit 12 receives a transaction including IoT terminal information related to an IoT terminal 2 from at least one IoT network 20 of the plurality of IoT networks 20. The communication unit 13 transmits and receives the transaction to/from another management terminal 1. The block generation unit 14 attempts to generate a block including the transaction. The block verification unit 15 verifies a block generated by another management terminal 1. The distributed ledger 16 stores the generated blocks.

As described above, in the present embodiment, the blockchain is used for an overlay network, whereby IoT terminal information on each IoT terminal in the plurality of IoT networks is stored in the distributed ledger of each management terminal 1. In other words, each management terminals 1 in the present embodiment can share IoT terminal information in the plurality of IoT networks. Therefore, a user can monitor the plurality of IoT networks 20 overall by referring to the distributed ledger of any one of the management terminals 1.

In the blockchain, information is autonomously exchanged through loose synchronization among the terminals, and the latest-state blockchain (IoT terminal information history) is stored nearly in real time in the distributed ledger of each management terminal 1. Accordingly, in the present embodiment, it is easy to newly add or delete an IoT network 20 and a management terminal 1, so that a workload required for scale out (a change to the system) can be reduced.

In IoT networks, the number of IoT terminals tends to increase with enhancement of the networks. On the other hand, IoT terminals themselves are vulnerable in general, and it happens frequently that an IoT terminal is detached from a network due to power-supply or network disconnection or the like. Therefore, if each individual IoT terminal is managed, IoT terminals to be managed need to be reconfigured in each management server each time an IoT terminal is added or deleted, and accordingly configuration work becomes complicated. By contrast, in the present embodiment, a management server does not need to be deployed for each IoT network 20, and accordingly, IoT terminal information does not need to be set in each management server each time an IoT terminal 2 is added or deleted. Moreover, in the present embodiment, since a management server does not need to be deployed for each IoT network 20, it is possible to avoid a system configuration from being large in scale and complicated.

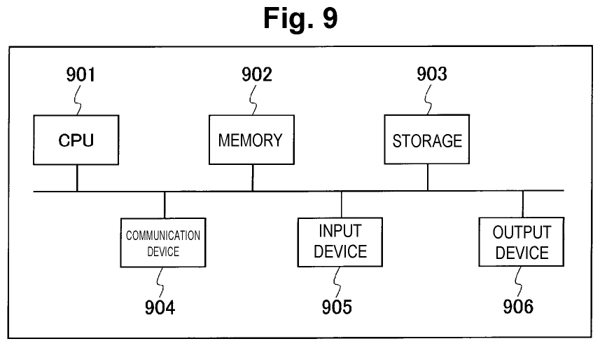

For each management terminal 1 and each IoT terminal 2 described above, for example, a general-purpose computer system as shown in FIG. 9 can be used. The depicted computer system includes a CPU (Central Processing Unit, processor) 901, a memory 902, a storage 903 (HDD: Hard Disk Drive, SSD: Solid State Drive), a communication device 904, an input device 905, and an output device 906. The memory 902 and the storage 903 are storage devices. In the computer system, the CPU 901 executes a predetermined program loaded on the memory 902, whereby each function of each device is implemented. For example, in a case of a program for the management terminals 1, the CPU of each management terminal 1 executes the program, and in a case of a program for the IoT terminals 2, the CPU of each IoT terminal 2 executes the program, whereby each function of the management terminals 1 and the IoT terminals 2 is implemented.

Each management terminal 1 may be implemented by using a single computer, or may be implemented by using a plurality of computers. Each management terminal 1 may be a virtual machine implemented on a computer.

The program for the management terminals 1 and the program for the IoT terminals 2 each can be stored in a computer-readable recording medium, such as an HDD, an SSD, a USB (Universal Serial Bus) memory, a CD (Compact Disc), or a DVD (Digital Versatile Disc), or can be distributed via a network.

The present invention is not limited to the above-described embodiment, and various changes can be made within the scope of the gist of the present invention.

### REFERENCE SIGNS LIST

1 Management terminal
10 Blockchain network
11 Blockchain control unit
12 Reception unit
13 Communication unit
14 Block generation unit
15 Block verification unit
2 IoT terminal
20 IoT network
21 Detection unit
22 Processing unit
23 Transaction generation unit
24 Communication unit
25 Storage unit

1. A data sharing system comprising:
a plurality of IoT networks; and
a plurality of management terminals that are connected to a blockchain network, wherein
each of the management terminals includes
a reception unit, including one or more processors, that is configured to receive a transaction including IoT terminal information related to an IoT terminal from at least one IoT network of the plurality of IoT networks,
a communication unit, including one or more processors, that is configured to transmit and receive the transaction to/from another management terminal,
a block generation unit, including one or more processors, that is configured to attempt to generate a block including the transaction,
a block verification unit, including one or more processors, that is configured to verify a block generated by another management terminal, and
a distributed ledger that is configured to store the generated blocks.

2. The data sharing system according to claim 1, wherein
each of the IoT networks includes a plurality of IoT terminals, and
each of the IoT terminals includes a transaction generation unit, including one or more processors, that is configured to generate the transaction including the IoT terminal information, and
a communication unit, including one or more processors, that is configured to transmit the transaction to at least one of the management terminals.

3. A management terminal connected to a blockchain network, the management terminal comprising:
a reception unit, including one or more processors, that is configured to receive a transaction including IoT terminal information related to an IoT terminal from at least one IoT network of a plurality of IoT networks;
a communication unit, including one or more processors, that is configured to transmit and receive the transaction to/from another management terminal;
a block generation unit, including one or more processors, that is configured to attempt to generate a block including the transaction;
a block verification unit, including one or more processors, that is configured to verify a block generated by another management terminal; and
a distributed ledger that is configured to store the generated blocks.

4. A data sharing method performed by a data sharing system, wherein
the data sharing system includes a plurality of IoT networks, and a plurality of management terminals connected to a blockchain network, the data sharing method comprising:
by each of the IoT networks, transmitting a transaction including IoT terminal information related to an IoT terminal to at least one management terminal;
by each of the management terminals,
receiving the transaction from at least one IoT network of the plurality of IoT networks;
transmitting and receiving the transaction to/from another management terminal;
attempting to generate a block including the transaction, or verifying a block generated by another management terminal; and
storing the generated block in a distributed ledger.

5. A recording medium storing a data sharing program, wherein executing of the data sharing program causes one or more computer to perform operations comprising:
receiving a transaction including IoT terminal information related to an IoT terminal from at least one IoT network of a plurality of IoT networks;
transmitting and receiving the transaction to/from another management terminal;
attempting to generate a block including the transaction;
verifying a block generated by another management terminal; and
storing the generated blocks in a distributed ledger.
